(19) United States
(12) Patent Application Publication
(10) Pub. No.: US 2020/0120850 A1
(43) Pub. Date: Apr. 23, 2020

(54) Insert for a Share for Uprooting Root Crop, Corresponding Set of Inserts, Share and Methods of Manufacture and Maintenance

(71) Applicant: Exel Industries, Epernay (FR)

(72) Inventors: Anton Neumeier, Straubing (DE); Eduard Richter, Hagelstadt/Gailsbach (DE)

(21) Appl. No.: 16/660,288

(22) Filed: Oct. 22, 2019

(30) Foreign Application Priority Data
Oct. 23, 2018 (EP) 18306381.7

(51) Int. Cl. A01B 15/04; A01D 25/02

(52) U.S. Cl. CPC A01B 15/04; A01D 25/02

(57) ABSTRACT

The present invention relates to an insert for a share for uprooting root crop, the insert having a first end adapted to form a portion remote from a cutting edge of the share, and a second end comprising an insert edge extending along an insert edge axis and adapted to form at least a portion of the cutting edge of the share, characterized in that the thickness of the insert, from the first end to the second end increases continuously and the second end has a thickness greater than a thickness of the first end. Further, the present invention relates to the replacement shares of root crop harvesting machines.

### CROSS-REFERENCE TO RELATED APPLICATIONS

This application claims priority to EP 18306381.7, filed on Oct. 23, 2018, which is 22, 2018, which is incorporated herein by reference in its entirety.

### BACKGROUND OF THE INVENTION

The present invention concerns an insert for a share for uprooting root crop, the insert having a first end adapted to form a portion remote from a cutting edge of the share, and a second end comprising an insert edge extending along an insert edge axis (IEA) and adapted to form at least a portion of the cutting edge of the share.

Shares for uprooting root crop, such as sugar beets are known from the state of the art.

Shares with inserts are for example known from DE10 2013 104 836. The share disclosed by this document comprises inserts having a roughly L-shape cross section and a rounded cutting edge. The inserts are however of complex shape, rather costly to manufacture and do still not satisfy the need of avoiding harming the roots during uprooting.

### BRIEF SUMMARY OF THE INVENTION

The objective of the invention is therefore to provide inserts and shares that are economic to manufacture and that allow high harvesting yield, in particular little loss of root crop mass during harvesting. A further objective of the invention is to provide corresponding methods that are economic.

In order to achieve at least one of the above objects the insert may have the following feature: the thickness of the insert, from the first end to the second end increases continuously and the second end has a thickness greater than a thickness of the first end.

According to specific embodiments, the insert according to the invention can comprise one or more of the following features, taken alone or together in all technical possible combinations:
the insert has a generating cross section (GCS) taken transversally or perpendicularly to the insert edge axis, that is generally polygonal, in particular trapezoidal;
the generating cross section is identical over a whole length or at least over 90% of the length measured along the insert edge axis of the insert and the insert comprises two end faces, in particular parallel end faces, extending transversal to the insert edge axis.

The invention relates also to a set of inserts for a share for uprooting crop, the set of inserts comprising:
at least two basic inserts each comprising the features according to any embodiment disclosed herein and each of the basic inserts being identical,
an upstream end insert and
a downstream end insert,

whereby each of the upstream end insert and the downstream end insert having a shape different from the shape of basic inserts,

whereby all the inserts of the set of inserts, when placed in succession adjacent one to another are adapted to form a continuous guiding surface for guiding root crop on a share for uprooting root crop, and wherein, for forming the guiding surface, the basic inserts are adapted to be placed in a succession adjacent one to another, the upstream end insert is adapted to be placed at an upstream end of the succession, the downstream end insert is adapted to be placed at a downstream end of the succession.

According to specific embodiments, the set of inserts according to the invention can comprise one or more of the following features, taken alone or together in all technical possible combinations:
the upstream end insert and/or the downstream end insert, has/have a trapezoidal or triangular shape having one arc-shape edge;
the set of inserts comprises at least one transitional insert having a shape different from the shape of the basic insert, the shape of the upstream end insert and the shape of the downstream end insert, and wherein for forming the guiding surface, the transitional insert is adapted to be arranged between either one of the basic inserts and the upstream end insert or between one of the basic inserts and the downstream end insert;
the transitional insert has, in a side view, an essentially trapezoidal shape.

The invention relates also to a share for uprooting crop, in particular beet crop, the share having a cutting edge for cutting in the soil, the cutting edge extending along a cutting edge axis (CEA), the share comprising:
a base body, which comprises an attachment portion adapted to attach the share to a support of a harvesting machine,
at least one insert fixed to the base body and forming at least a portion of the cutting edge, wherein

either
the insert is an insert according to any embodiment disclosed herein,

or
the share has a set of inserts according to any embodiment disclosed herein, the insert being one of the basic inserts of the set of inserts;

and
the first end of the insert forms a portion remote from the cutting edge of the share, and the insert edge forming at least a portion of the cutting edge of the share.

According to specific embodiments, the insert according to the invention can comprise one or more of the following features, taken alone or together in all technical possible combinations:
the base body comprises a base body edge face,
the insert comprises an insert edge face,
the base body edge face and the insert edge face form together a convex profile;
the or each insert comprises a surface that is harder than a surface of the base body, in particular the or each insert having a hardness between 60 HRC and 80 HRC and preferably between 65 HRC and 75 HRC;
the base body comprises
a stop face, the stop face being angled and comprising a main section and a downstream section extending at an angle one to another;
and at least the downstream end insert being adjacent and in contact with the downstream section and at least one basic insert being adjacent and in contact with the main section.

The invention relates also to a method of manufacture of a share according to at least an embodiment disclosed herein, comprising the steps of:
providing the or each insert;
providing the base body, and
fixing the or each insert on the base body, in particular by soldering.

The invention relates also to a method of maintenance of a root crop harvesting machine comprising at least two share supports with worn uprooting shares, comprising the steps of:
unmounting of the worn uprooting shares from the share supports;
providing at least two replacement uprooting shares, each replacement uprooting share being a share according to an embodiment disclosed herein and being in a state of wear less than the worn shares;
mounting the replacement uprooting shares onto the share supports.

Within the scope of this patent application, the various aspects, embodiments, examples, features and alternatives set out in the preceding paragraphs, in the claims, and/or in the following description and drawings may be taken independently or in any combination thereof. For example, features disclosed in connection with one embodiment are applicable to all embodiments, except where there is technical incompatibility of features. Also, for any combination of features that is disclosed, it is contemplated that the features can also be isolated and used individually or as any possible subset of the combination of features.

### BRIEF DESCRIPTION OF TH DRAWINGS

The invention will be better understood in light of the following specification of an embodiment, which refers to the annexed figures showing:

FIG. 1 a side view of the active side of a share for uprooting beet crop;

FIG. 2 a side view of the passive side of the share for uprooting beet crop of FIG. 1;

FIG. 3 a cut along line III-III of FIG. 1;

FIG. 4 a view of the lower side of the share for uprooting beet crop of FIG. 1;

FIG. 5 a cross-cut along line V-V of FIG. 1 and a portion of the support for the share of a harvesting machine; and

FIG. 6 the detail VI of FIG. 5 in greater detail.

### DETAILED DESCRIPTION OF THE INVENTION

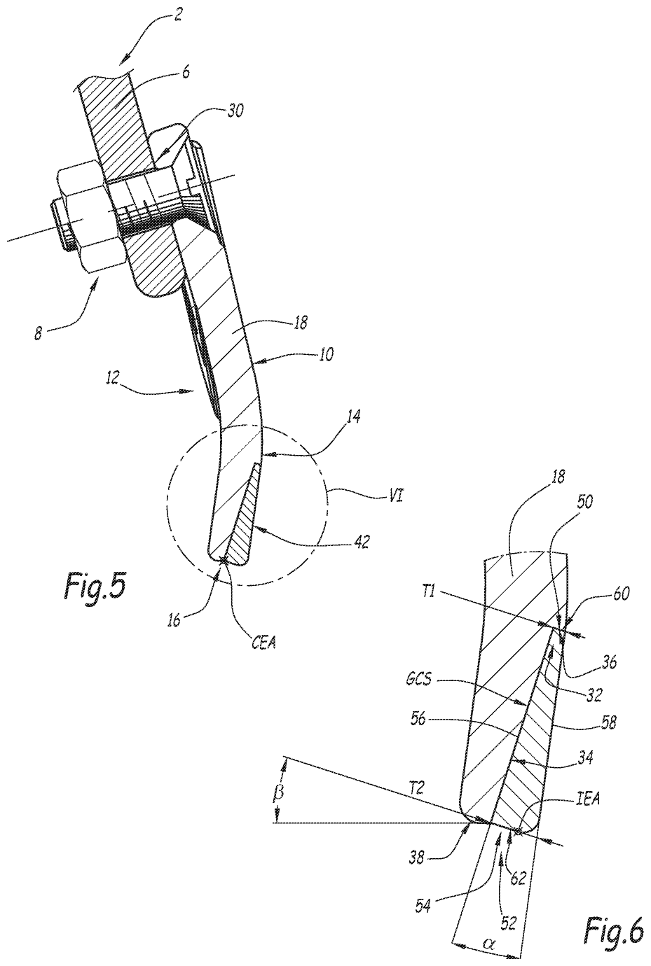

On FIG. 5 is shown a portion of a harvesting machine 2, namely an uprooting share 4, a share support 6 and fixing means 8, in the present case nuts and bolts.

The harvesting machine 2 is adapted to uproot root crop, in particular beet crop, and specifically sugar beets. The harvesting machine 2 is as such known from the prior art and is for example of the Terra Dos type by Holmer Maschinenbau.

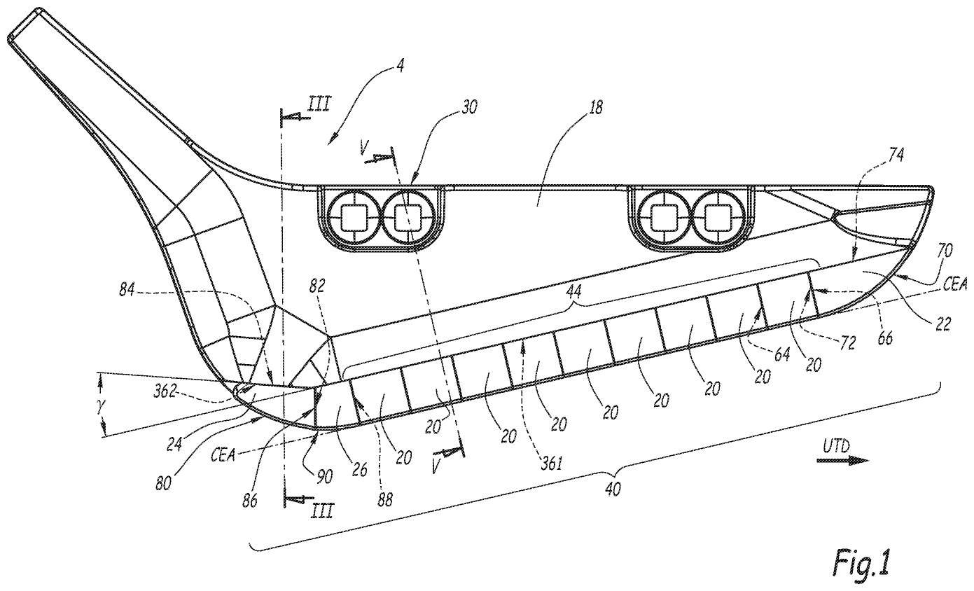

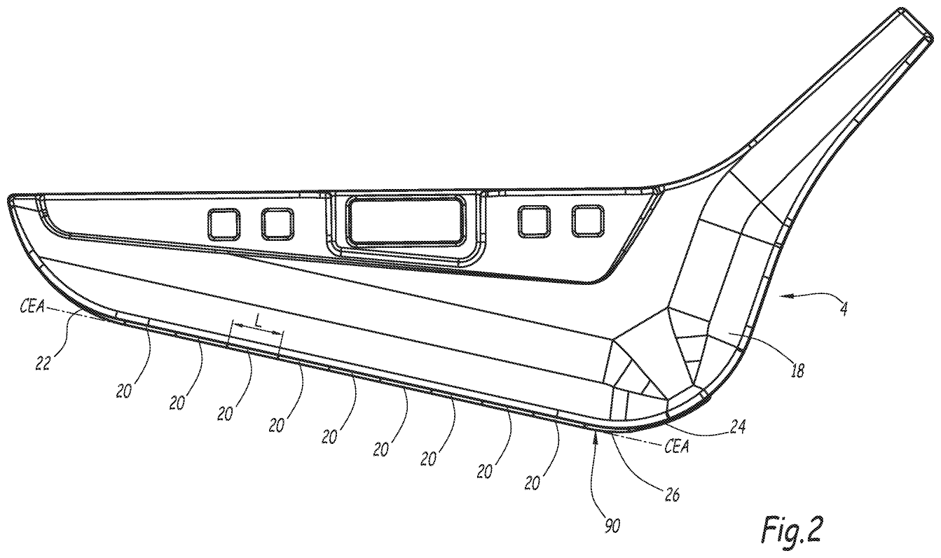

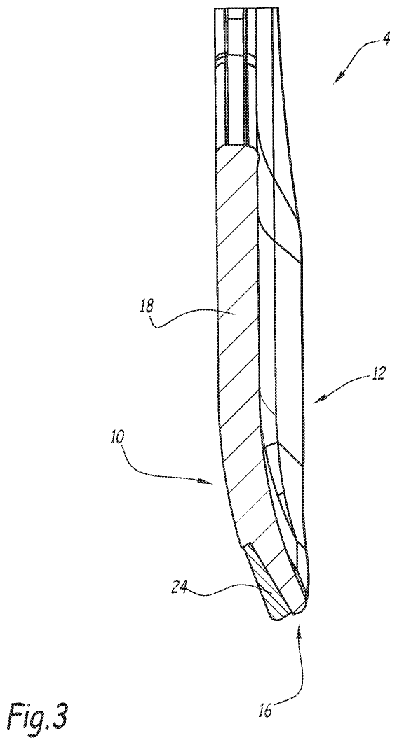

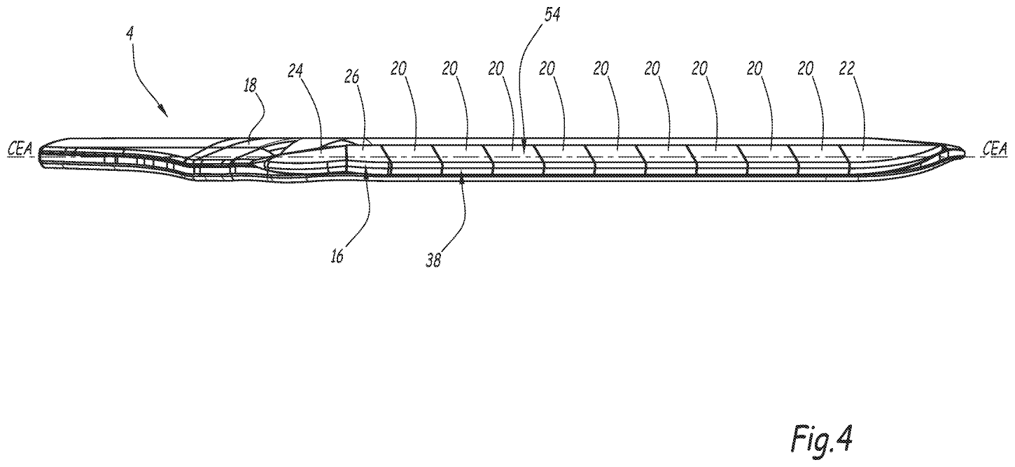

The harvesting machine 2 has an uprooting travel direction UTD, which is to the right on FIG. 1.

The harvesting machine 2 comprises, for each working row of crop to be uprooted, a pair of uprooting shares 4 which is adapted to push the root crop out of the soil during advancement of the harvesting machine.

Only one uprooting share 4 is depicted and here below explained. The other uprooting share of the pair of uprooting shares is symmetrical to the uprooting share shown on the Figures with respect to a plane of symmetry parallel to the plane of FIG. 1 and above the plane of FIG. 1.

The uprooting share 4 has an active side 10 adapted to come into contact with the crop to be uprooted and a passive side 12, turned away from the crop to be uprooted.

The active side 10 forms a closed working surface 14 that is generally convex.

The uprooting share 4 has a cutting edge 16 for cutting into the soil and extending along a cutting edge axis CEA.

The uprooting share 4 comprises a base body 18, basic inserts 20, an upstream end insert 22, a downstream end insert 24 and a transitional insert 26.

The base body 18 comprises an attachment portion 30 for attachment of the uprooting share to the share support 6.

The base body 18 comprises also a step 32 or recess having a shape complementary to the shape of the inserts and adapted to receive the corresponding inserts 20, 22, 24, 26 (FIG. 6). The step 32 is formed by a plane surface 34 that is inclined with respect to a corresponding surface of the passive side 12. The step 32 is shaped so that the thickness of the base body diminishes towards the cutting edge 16. The step 32 is also formed by a stop surface 36 perpendicular to the plane surface 34 and extending essentially parallel to the cutting edge axis.

The base body 18 comprises a base body edge face 38 extending along the cutting edge axis CEA.

The uprooting share 4 comprises in the present case nine of the basic inserts 20, one upstream end insert 22, one downstream end insert 24 and one transitional insert 26. The inserts form together a set of inserts 40. All the inserts 20, 22, 24, 26 of the set of inserts 40, when placed in succession adjacent one to another and as shown on the Figures form a continuous guiding surface 42 for guiding root crop on the uprooting share. For forming the guiding surface 42, the basic inserts 20 are placed in a succession 44 adjacent one to another, the upstream end insert 22 is placed at an upstream end of the succession 44 and the downstream end insert 24 is placed at a downstream end of the succession 44.

In the present case, the upstream end insert 22 is placed adjacent a basic insert 20 and the transitional insert 26 is interposed between the downstream end of the succession 44, adjacent a basic insert 20 and adjacent the downstream end insert 24. Generally, for forming the guiding surface 42, the transitional insert 26 can be arranged either between and adjacent to one of the basic inserts 20 and the upstream end insert 22 or between and adjacent to one of the basic inserts 20 and the downstream end insert 24. The transitional insert 26 is optional and can be omitted. In this case the upstream end insert 22 and the downstream end insert 24 are placed adjacent a basic insert 20.

Advantageously, each of the basic inserts 20 of the set of inserts 40 is identical. Each of the upstream end insert 22 and the downstream end insert 24 have a shape different from the shape of the basic insert 20. The transitional insert 26 has a shape different from the shape of basic insert 20, the upstream end insert 22 and the downstream end insert 24.

Each of the basic inserts 20 has a first end 50 adapted to form a portion remote from the cutting edge 16 of the uprooting share, and a second end 52 comprising an insert edge 54 extending along an insert edge axis IEA and adapted to form at least a portion of the cutting edge 16 of the uprooting share. The thickness of the insert 20, from the first end 50 to the second end 52 increases continuously and the second end 52 has a thickness T2 greater than a thickness T1 of the first end 50. The thickness is generally measured perpendicularly to a plane containing the insert edge axis.

The fact that the thickness of the insert 20, from the first end 50 to the second end 52 increases continuously does not exclude that the first end 50 and/or the second end 52 present rounded off portions or fillets at their edge locations or beveled edges. These fillets and bevels, where present, are generally smaller than a thickness of the insert. This can also be seen on FIG. 6, where the thickness T2 of the second end 52 is the distance of the first side face 56 and the second side face 58 measured along the edge face 62 and at the location of the edge face 62.

The expression “remote from the cutting edge” is to be understood as opposed to the expression “forming a portion of the cutting edge”.

Each of the basic inserts 20 has a generating cross section GCS, taken transversally or perpendicularly to the insert edge axis IAE, that is generally polygonal, in particular trapezoidal. In particular, as in the present case, the generating cross section GCS is over its whole circumference strictly convex. Alternatively, the generating cross section GCS could also be over its whole circumference strictly convex, except one single concave section.

Generally, the generating cross section GCS is identical over the whole length L or at least 90% of the length of the basic insert 20, measured along the insert edge axis IEA, of the insert.

In other words, the outer surface of each the basic insert 20 comprises a first side face 56, a second side face 58, a stop face 60 and an edge face 62. The first side face 56 and the second side face 58 are plane faces and are inclined one to another by an angle α preferably comprised between 8° and 12°. The first side face 56 is applied against the plane surface 34.

The stop face 60 and the edge face 62 are plane faces and are generally parallel one to another. The second side face and the edge face 62 are connected one to another by a fillet. The stop face and the edge face are generally perpendicular to the first side face.

The basic insert 20 comprises two end faces 64, 66 (FIG. 1). The end faces 64, 66 are generally planar and in particular parallel one to another. The end faces 64, 66 extend transversally or perpendicularly to the insert edge axis and thus to the first side face 56, second side face 58, stop face 60 and edge face 62.

The basic insert 20 has therefore the general shape of a truncated wedge.

The upstream end insert 22 has, in a side view, a triangular shape having one arc-shaped edge 70. The upstream end insert 22 has an end face 72 mating with the end face 66 of the adjacent basic insert 20 and a face 74 mating with the stop surface 36 of the base body 18. The faces 72, 74 are preferably perpendicular one to another.

The downstream end insert 24 has, in a side view, a truncated triangular shape or trapezoidal shape having one arc-shaped edge 80. The downstream end insert 22 has a an end face 82 mating with the end face 86 (see below) of the adjacent transitional insert 26 and a face 84 mating with the stop surface 36 of the base body 18. The end face 82 and the face 84 are preferably perpendicular one to another.

More particularly, the stop face 36 is in the present case angled and comprises a main section 361 and a downstream section 362 extending at an angle one to another (see FIG. 1). The main section 361 may be straight and the downstream section may also be straight. In the present case, the main section 361 and downstream section 362 form angle γ one with another, that is bigger than 0° and preferably comprised between 5° and 30°. Consequently, the most downstream portion of the downstream end insert 24 is offset away from the cutting edge axis CEA and is subject to little wear. Consequently, the downstream end insert 24 is not prone to detachment from the base body 18.

Generally, the downstream section 361 can be adjacent only the downstream end insert 24 or also adjacent to the transitional insert(s) 26.

Generally the share can be designed so that at least the downstream end insert 24 is adjacent and in contact with the downstream section 362 and at least one basic insert is adjacent and in contact with the main section 361.

The transitional insert 26 has, in a side view, an essentially trapezoidal shape. The transitional insert 26 has an end face 86, adjacent the downstream end insert 24, and an end face 88, adjacent a basic insert 20.

The transitional insert 26 has, in a side view, one arc-shaped edge 90. The arc-shaped edge 90 forms part of the cutting edge 16.

Generally, the uprooting share 4 has at least one insert fixed to the base body and forming at least a portion of the cutting edge. The insert can be either one of the basic inserts 20, the upstream end inserts 22 or the downstream end insert 24, or the transitional insert 26. Generally, the first end of the insert forms a portion of the insert remote from the cutting edge of the share, and the insert edge forms at least a portion of the cutting edge of the uprooting share.

The base body edge face 38 and the insert edge face 62 form together a concave profile. This profile is taken for example in a plane transversal or perpendicular to the cutting edge axis CEA and can be seen on FIG. 6. The body edge face 38 and the insert edge face 62 are arranged one to another according to an angle β bigger than 0° and at most 40°. Preferably, the angle β is comprised between 5° and 15° and advantageously comprised between 8° and 12°.

This concave profile allows for relatively little wear on the base body 18 and the inserts, as the edge face of the inserts protects the edge of the base body from contact with soil. Consequently, the transitional zone between the inserts and the base body is not “washed out” by soil.

At least one, preferably more of and particularly each of the basic inserts 20, upstream end insert 22, downstream end insert 24 and transitional insert 26 has a surface that is harder than the surface of the base body 18. The hardness of the base body 18, at least in a working zone near and adjacent the inserts, is comprised between 45 HRC and 52 HRC and preferably between 47 HRC and 50 HRC.

The corresponding insert can have a hardness between 60 HRC to 80 HRC and more preferably a hardness of 65 HRC to 75 HRC Each of the inserts is for example manufactures by sintering out of a pressed green body.

The uprooting share 4 is manufactured as follows. The or each of the basic inserts 20, the upstream end inserts 22, the downstream end insert 24, and optionally the transitional insert 26 are provided. The base body 14 is provided. Then the or each insert is fixed on the base body 14, in particular by soldering.

The invention relates also to a method of maintenance of a root crop harvesting machine comprising at least two share supports with worn shares. When the shares are worn they need to be replaced. The replacement method is as follows. The worn uprooting shares are unmounted from the share supports. Two replacement uprooting shares, each replacement uprooting share being an uprooting share as disclosed above and being in a state of wear less than the worn uprooting shares are provided. In particular the replacement uprooting shares are new uprooting shares. Finally, the replacement uprooting shares are mounted onto the share supports.

1. An insert for a share for uprooting root crop, the insert comprising:
a first end adapted to form a portion remote from a cutting edge of the share, and a second end comprising an insert edge extending along an insert edge axis and adapted to form at least a portion of the cutting edge of the share.

2. The insert according to claim 1, wherein the thickness of the insert, from the first end to the second end increases continuously and the second end has a thickness greater than a thickness of the first end.

3. The insert according to claim 1, wherein the insert has a generating cross section, taken transversally or perpendicularly to the insert edge axis, that is generally polygonal.

4. The insert according to claim 3, wherein the generating cross section is trapezoidal.

5. The insert according to claim 1, wherein the generating cross section is identical over a whole length or at least over 90% of the length measured along the insert edge axis of the insert and the insert comprises two end faces extending transversal to the insert edge axis.

6. The insert according to claim 5, wherein the two end faces are parallel end faces.

7. A set of inserts for a share for uprooting crop, the set of inserts comprising:
at least two basic inserts, wherein each basic insert comprises a first end adapted to form a portion remote from a cutting edge of the share, and a second end comprising an insert edge extending along an insert edge axis and adapted to form at least a portion of the cutting edge of the share;
an upstream end insert; and
a downstream end insert;
wherein the upstream end insert and the downstream end insert each have a shape that is different from the shape of basic inserts; and
wherein all the inserts of the set of inserts, when placed in succession adjacent one to another, are adapted to form a continuous guiding surface for guiding root crop on a share for uprooting root crop; and
wherein, for forming the guiding surface, the basic inserts are adapted to be placed in a succession adjacent one to another, the upstream end insert is adapted to be placed at an upstream end of the succession, and the downstream end insert is adapted to be placed at a downstream end of the succession.

8. The set of inserts for a share for uprooting crop according to claim 7, wherein
the upstream end insert and/or the downstream end insert, has/have a trapezoidal or triangular shape having one arc-shape edge.

9. The set of inserts for a share for uprooting crop according to claim 7, wherein
the set of inserts comprises at least one transitional insert having a shape different from the shape of the basic insert, the shape of the upstream end insert and the shape of the downstream end insert, and wherein
for forming the guiding surface, the transitional insert is adapted to be arranged between either one of the basic inserts and the upstream end insert or between one of the basic inserts and the downstream end insert.

10. The set of inserts for a share for uprooting crop according to claim 9, wherein the transitional insert has, in a side view, an essentially trapezoidal shape.

11. A share for uprooting crop, wherein the share has a cutting edge for cutting in the soil and the cutting edge extends along a cutting edge axis, the share comprising:
a base body, which comprises an attachment portion adapted to attach the share to a support of a harvesting machine; and
at least one insert fixed to the base body and forming at least a portion of the cutting edge, wherein the at least one insert fixed to the body is either: the insert according to claim 1 or one of the basic inserts of the set of inserts according to claim 7;
wherein the first end of the insert forms a portion remote from the cutting edge of the share, and the insert edge forming at least a portion of the cutting edge of the share.

12. The share for uprooting crop according to claim 11, wherein the share is for uprooting beet crop.

13. The share for uprooting crop according to claim 11, wherein:
the base body comprises a base body edge face;
the insert comprises an insert edge face; and
the base body edge face and the insert edge face form together a convex profile.

14. The share according to claim 11, wherein the or each insert comprises a surface that is harder than a surface of the base body.

15. The share according to claim 14, wherein the or each insert has a hardness between 60 HRC and 80 HRC or between 65 HRC and 75 HRC.

16. The share according to claim 11, wherein the base body comprises:
a stop face, the stop face being angled and comprising a main section and a downstream section extending at an angle one to another; and
at least the downstream end insert being adjacent and in contact with the downstream section and at least one basic insert being adjacent and in contact with the main section.

17. A method of manufacture of a share according to claim 11, the method comprising:
providing the or each insert;
providing the base body; and
fixing the or each insert on the base body or fixing the or each insert on the base body by soldering.

18. A method of maintenance of a root crop harvesting machine comprising at least two share supports with worn uprooting shares, comprising:
unmounting of the worn uprooting shares from the share supports;
providing at least two replacement uprooting shares, each replacement uprooting share being a share according to claim 11 and being in a state of wear less than the worn shares; and
mounting the replacement uprooting shares onto the share supports.
